(19) United States
(12) Patent Application Publication
(10) Pub. No.: US 2003/0071699 A1
(43) Pub. Date: Apr. 17, 2003

(54) Microwave transverse electromagnetic delay line

(75) Inventor: Peter Michael Waltz, Exeter, NH (US)

Correspondence Address: TYCO Technology Resources, Suite 450, 4550 New Linden Hill Road, Wilmington, DE, 19808-2952, US

(73) Assignee: TYCO ELECTRONICS CORPORATION

(21) Appl. No.: 09/977,433

(22) Filed: Oct. 15, 2001

(51) Int. Cl. H01P 1/18

(52) U.S. Cl. 333/162; 333/160

(57) ABSTRACT

A low-loss, phase stable, microwave transverse electromagnetic delay line having an increased lifetime and a reduced cost of manufacture. The microwave delay line includes a TEM transmission line having a central conductor, a dielectric material covering the length of the central conductor, and a solid outer conductor on which the dielectric-covered central conductor is wound. The outer conductor includes at least one guide formed on a surface thereof into which the dielectric-covered central conductor is disposed. The microwave delay line further includes two microwave connectors mounted at respective ends of the outer conductor and operatively coupled to corresponding ends of the central and outer conductors, and a metal cover configured to enclose the microwave delay line to prevent signal leakage and protect the microwave delay line from environmental damage.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to microwave delay lines, and more specifically to a microwave transverse electromagnetic delay line having an increased lifetime and a reduced cost of manufacture.

Microwave delay lines are commonly employed as memory elements in radar and communications systems and other microwave systems for temporarily storing microwave signals during processing. A conventional microwave delay line operates in a transverse electromagnetic (TEM) field configuration and comprises a length of coaxial cable including a central conductor, an outer conductor, and a layer of dielectric material disposed between the central and outer conductors. The central conductor is typically made of a solid material, e.g., copper, and the outer conductor is typically stranded, then covered by an insulative, protective coating. Further, the coaxial cable is often wound on a mounting or support structure to form a compact unit for subsequent incorporation into the target microwave system.

Although conventional microwave delay lines have been successfully employed in the processing of microwave signals, such microwave delay lines have drawbacks in that exposure to thermal cycling can lead to loss changes and/or phase changes in the delay lines. This is due, at least in part, to the multiple elements of the outer conductor forming contact spots along the outer conductor's length, which can undergo degradation when the microwave delay line is exposed to repeated thermal cycles. Such contact degradation can cause loss change and/or phase change, significantly reducing the lifetime of the microwave delay line.

It would therefore be desirable to have a more durable microwave delay line that can be employed in Radio Frequency (RF) or microwave applications. Such a microwave delay line would have an increased lifetime relative to conventional microwave delay line implementations. It would also be desirable to have a microwave delay line that can be manufactured at reduced cost.

### BRIEF SUMMARY OF THE INVENTION

In accordance with the present invention, a low-loss, phase stable, microwave transverse electromagnetic (TEM) delay line is disclosed that has an increased lifetime and a reduced cost of manufacture. Benefits of the presently disclosed microwave TEM delay line are achieved by fabricating an outer conductor of the microwave delay line from a solid electrically conductive material, which can be configured to provide a mounting or support structure for the delay line.

In one embodiment, the microwave delay line is configured to operate in a TEM field configuration. The microwave TEM delay line comprises a TEM transmission line including a central conductor, a layer of dielectric material covering the length of the central conductor, and a solid outer conductor on which the dielectric-covered central conductor is wound. The outer conductor includes at least one guide formed on a surface thereof into which the dielectric-covered central conductor is disposed. In a preferred embodiment, the geometric shape of the outer conductor is substantially cylindrical, and the guide formed on the outer conductor surface comprises a helical groove. The microwave TEM delay line further includes two (2) microwave connectors mounted at respective ends of the outer conductor and operatively coupled to corresponding ends of the central and outer conductors, and a metal cover configured to enclose the microwave TEM delay line to prevent signal leakage and protect the microwave delay line from environmental damage.

By configuring the microwave TEM delay line to include a solid outer conductor having at least one guide formed on a surface thereof into which a dielectric-covered central conductor is disposed, the microwave delay line exhibits significantly less loss change and/or phase change when exposed to repeated thermal cycles. This is, at least in part, because the solid outer conductor comprises no contact spots that can degrade from such exposure to thermal cycling. Further, because providing the microwave delay line with the solid outer conductor simplifies the process for manufacturing the delay line, costs of manufacture can be reduced.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 is a partially exploded perspective view of a microwave transverse electromagnetic delay line according to the present invention;

FIG. 2 is a perspective view of an outer conductor included in the microwave transverse electromagnetic delay line of FIG. 1;

FIG. 3 is a first cross-sectional detail view of the microwave transverse electromagnetic delay line of FIG. 1 illustrating portions of the outer conductor, a guide formed on a surface of the outer conductor, a dielectric-covered central conductor disposed in the guide, and a metal cover enclosing the microwave delay line;

FIG. 4 is a second cross-sectional detail view of the microwave transverse electromagnetic delay line of FIG. 1 illustrating portions of the outer conductor, the guide formed on the outer conductor's surface, the dielectric-covered central conductor disposed in the guide, and a microwave connector mounted on the outer conductor and operatively coupled to corresponding ends of the outer and central conductors;

FIG. 5 is a perspective view of a first alternative embodiment of the outer conductor of FIG. 2, in which the outer conductor is embodied in a planar rectangular structure with the guide formed in a serpentine configuration on the outer conductor surface;

FIG. 6 is a perspective view of a second alternative embodiment of the outer conductor of FIG. 2, in which the outer conductor is embodied in a planar circular structure with the guide formed in a spiral configuration on the outer conductor surface; and

FIG. 7 is a third cross-sectional detail view of the microwave transverse electromagnetic delay line of FIG. 1, in which the outer conductor is extended by way of a conductive, elongated, flexible or semi-rigid link.

### DETAILED DESCRIPTION OF THE INVENTION

A microwave transverse electromagnetic (TEM) delay line is disclosed having an increased lifetime and a reduced manufacturing cost. The presently disclosed microwave TEM delay line comprises a TEM transmission line including an outer conductor made of a solid electrically conductive material, which resists degradation from exposure to thermal cycling and simplifies processes for manufacturing the microwave delay line.

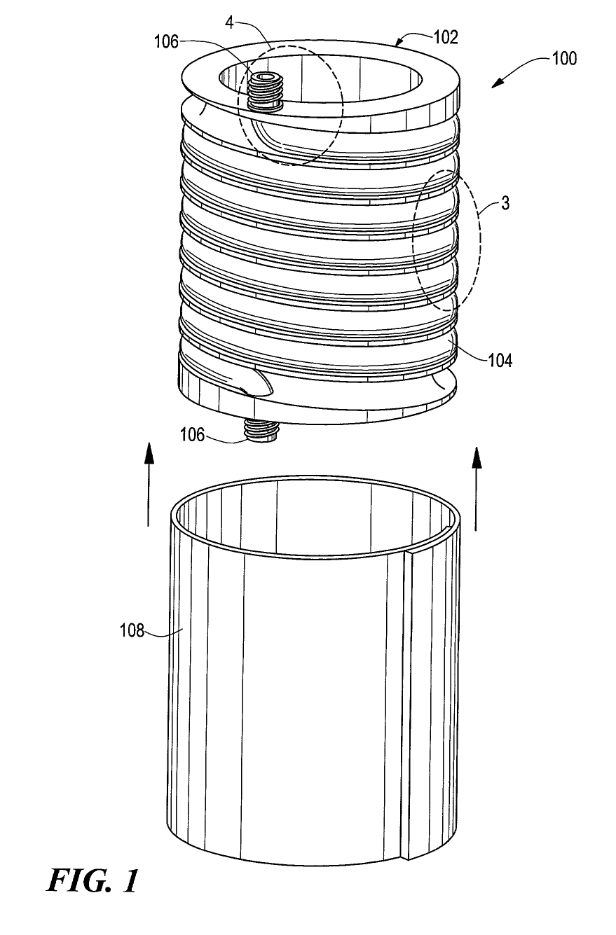

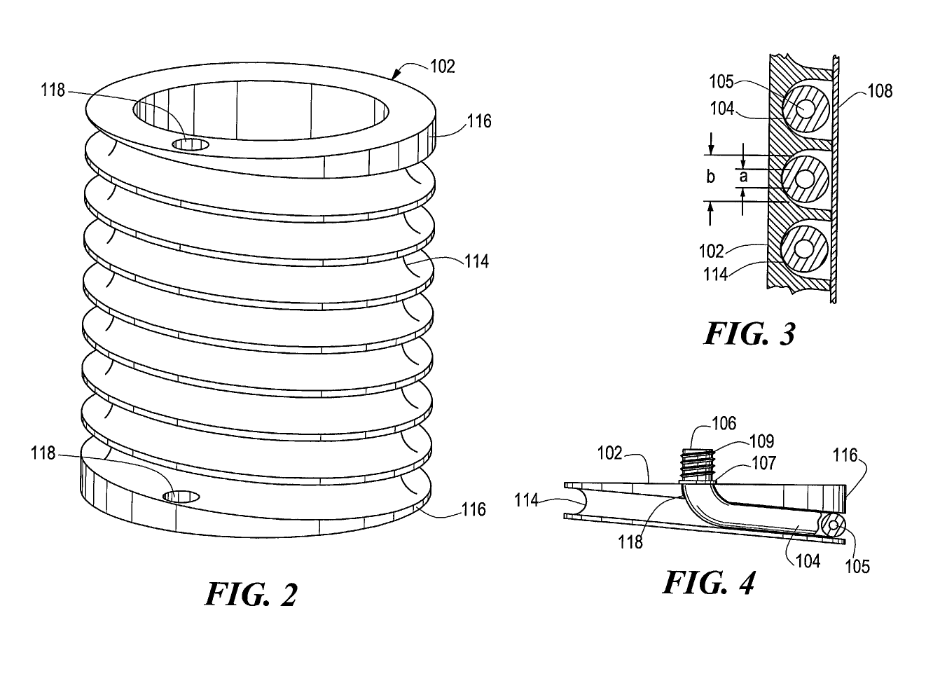

FIG. 1 depicts a partially exploded perspective view of a microwave TEM delay line 100, in accordance with the present invention. In the illustrated embodiment, the microwave TEM delay line 100 is configured to operate in a TEM field configuration. Further, the microwave TEM delay line 100 comprises a TEM transmission line including a central conductor 105 (see FIG. 3), a layer of dielectric material 104 covering the length of the central conductor 105, and a solid outer conductor 102 on which the dielectric-covered central conductor 105 is helically wound.

For example, the central conductor 105 may be made of copper or any other suitable electrically conductive material, and the dielectric material 104 may comprise a fluoropolymer such as polytetrafluoroethylene (PTFE, also known as TEFLON™) or any other suitable dielectric material. Further, the solid outer conductor 102 may be made of copper, aluminum, or any other suitable electrically conductive material or composite.

Specifically, the outer conductor 102 is configured as a mounting or support structure for the dielectric-covered central conductor 105, which is helically wound a number of turns on the outer conductor 102. In the illustrated embodiment, the outer conductor 102 has a geometric shape that is substantially cylindrical with a cross-section that is substantially circular. It should be understood, however, that the outer conductor 102 of the microwave TEM delay line 100 may alternatively have a geometric shape with a rectangular or elliptical cross-section or any other geometric shape/cross-section suitable to form a compact unit that may be subsequently incorporated into a Radio Frequency (RF) or microwave device or system. Further, as shown in FIG. 1, the outer conductor 102 is hollow with open ends (not numbered).

The microwave TEM delay line 100 further includes two (2) microwave connectors 106 mounted at the respective ends of the outer conductor 102 and operatively coupled to corresponding ends of the outer and central conductors 102 and 105, and a metal cover 108 configured to enclose the microwave TEM delay line 100 to prevent signal leakage and protect the microwave delay line from environmental damage. The two (2) microwave connectors 106 correspond to respective input and output ports of the microwave delay line 100. Further, the metal cover 108 is cylindrical and may be slid over the outer conductor 102 in the direction shown so that the metal cover 108 encloses the substantial length of the outer conductor 102, which has the dielectric-covered central conductor 105 helically wound thereon. It is understood, however, that the metal cover 108 may have alternative geometric shapes to match the overall shape of the microwave TEM delay line 100. For example, a thin metal plate may be employed to form the cylindrical metal cover 108. Moreover, the metal plate of the cover 108 may be made of copper, aluminum, metallized plastic, or any other suitable metallic or metallized material or composite.

FIG. 2 depicts a perspective view of the outer conductor 102 included in the microwave TEM delay line 100 (see FIG. 1). As described above, the dielectric-covered central conductor 105 (see FIG. 3) is helically wound a number of turns on the outer conductor 102. In the illustrated embodiment, the outer conductor 102 includes at least one guide 114 formed on a surface thereof into which the dielectric-covered central conductor 105 is disposed. Specifically, the guide 114 comprises a helical groove formed on the outer surface of the outer conductor 102. For example, a suitable ball-end-mill cutting tool may be employed to form the guide 114 with a rounded U-shaped cross-section on the outer surface of the outer conductor 102, or a suitable flat-end-mill cutting tool may be employed to form the guide 114 with a flattened U-shaped cross-section. Alternatively, the outer conductor 102 with the guide 114 formed thereon may be cast in a suitable mold. Further, because the illustrated embodiment of the outer conductor 102 is hollow with open ends, the guide 114 may alternatively be formed on the inner surface of the outer conductor 102. It should be understood that the guide 114 may be formed in the outer conductor 102 with alternative cross-sections that at least partially encompass the dielectric-covered central conductor 105 disposed therein.

FIG. 3 depicts a cross-sectional detail view of the microwave TEM delay line 100 (see FIG. 1) illustrating portions of the outer conductor 102 including the guide 114 formed on the outer conductor's outer surface, the dielectric-covered central conductor 105 disposed in the guide 114, and the metal cover 108 enclosing the guide 114 with the dielectric-covered central conductor 105 disposed therein. As shown in FIG. 3, the guide 114 is formed on the outer surface of the outer conductor 102 with a rounded U-shaped cross-section. Further, the dielectric-covered central conductor 105 is helically wound on the outer conductor 102 so that it is disposed in the guide 114 along the trough of the U-shaped cross-section. FIG. 3 shows cross-sections of three (3) adjacent turns of the dielectric-covered central conductor 105 disposed in the guide 114. Moreover, the metal cover 108 encloses the microwave delay line such that the cover 108 rests against the outer surface of the outer conductor 102 at points protruding between the adjacent turns of the dielectric-covered central conductor 105.

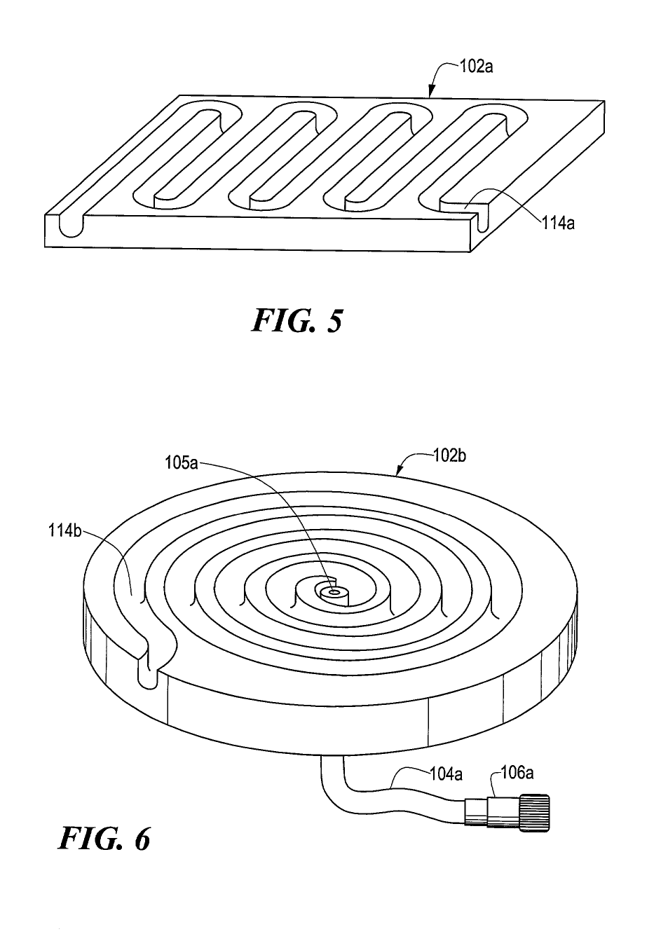

FIG. 4 depicts another cross-sectional detail view of the microwave TEM delay line 100 (see FIG. 1) illustrating portions of the outer conductor 102, the guide 114, the dielectric-covered central conductor 105, and one of the two (2) microwave connectors 106 mounted on the outer conductor 102 and operatively coupled to corresponding ends of the outer and central conductors 102 and 105. As described above, the guide 114 is formed on the outer conductor's outer surface and comprises a helical groove. FIG. 4 shows that the helical groove of the guide 114 forms lips 116 (see also FIG. 2) at the respective ends of the outer conductor 102. In the illustrated embodiment, the microwave connectors 106 are mounted on the lips 116 at the respective ends of the outer conductor 102. Specifically, the microwave connector 106 includes a flange 107 configured to be mounted on the lip 116, and a circular port 109 operatively disposed within the flange 107. Further, holes 118 are formed in the lips 116 at the respective ends of the outer conductor 102, and ends of the dielectric-covered central conductor 105 pass through the respective holes 118 to allow the microwave connectors 106 to be operatively coupled to the corresponding ends of the outer and central conductors 102 and 105.

For example, the microwave connector 106 may comprise an SMA connector or any other suitable RF or microwave connector. Moreover, it should be appreciated that the microwave connectors 106 may be mounted at alternative locations on the inner or outer surfaces of the outer conductor 102 or at any other suitable location, and the outer conductor 102 may be suitably configured to allow the microwave connectors 106 to be operatively coupled to the outer and central conductors 102 and 105 at these alternative mounting locations.

It should also be appreciated that the outer conductor 102 may alternatively comprise a solid body, including planar structures. For example, FIG. 5 depicts an alternative outer conductor 102a, which comprises a planar rectangular structure including a guide 114a formed in a serpentine configuration on the outer conductor surface. Further, FIG. 6 depicts another alternative outer conductor 102b, which comprises a planar circular structure including a guide 114b formed in a spiral configuration on the outer conductor surface. As shown in FIG. 6, a TEM transmission line including a central conductor 105a, a layer of dielectric material 104a covering the length of the central conductor 105a, and a microwave connector 106a mounted at an end thereof may access the guide 114b via a hole (not numbered) formed in the approximate center of the planar circular structure.

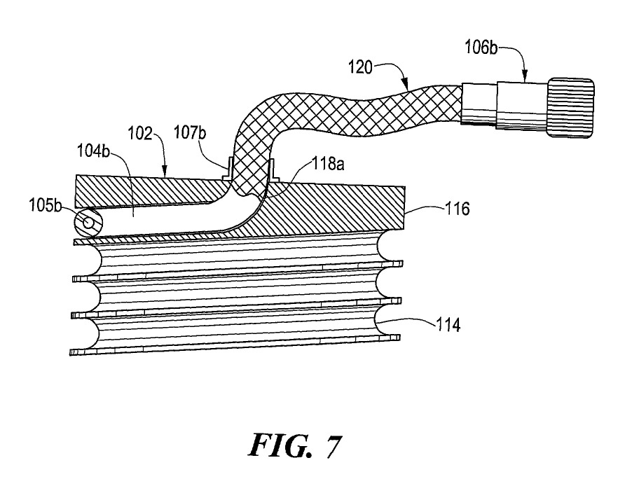

FIG. 7 depicts still another cross-sectional detail view of the microwave TEM delay line 100 (see FIG. 1), in which the outer conductor 102 is effectively extended by way of a conductive, elongated, flexible or semi-rigid link 120 configured to at least partially encompass a dielectric-covered central conductor 105b disposed therein. In the illustrated embodiment, the central conductor 105b, which is covered by a dielectric layer 104b and partially disposed in the helical guide 114, passes through a hole 118a in the lip 116. Further, the dielectric-covered central conductor 105b extends through the conductive link 120 to allow a microwave connector 106b to be operatively coupled to corresponding ends of the conductive link 120 and the central conductor 105b. A flange 107b mounted on the lip 116 is configured to form a good electrical connection between the outer conductor 102 and the conductive link 120. It is noted that one or both ends of the outer conductor 102 may be effectively extended in the above-described manner.

The illustrated embodiment of the microwave TEM delay line 100 (see FIG. 1) will be better understood with reference to the following example. In this illustrative example, the characteristic impedance at the input and output of the microwave delay line 100 is estimated using the following expression:

Z₀=ν_{ρ}138log(1.10)(b/a), (1)

in which “ν_{ρ}” is the velocity of propagation of an RF or microwave signal propagating on the delay line, “b” (see FIG. 3) is the overall diameter of the central conductor 105 covered by the dielectric material 104, and “a” (see FIG. 3) is the diameter of the central conductor 105. In this example, the dielectric material 104 comprises a relatively low density PTFE, e.g., ρ≈1.20 g/cm³, which corresponds to a velocity of propagation, ν_{τ}, of about 0.81. Further, a suitable ball-end-mill cutting tool is employed to form the helical groove of the guide 114 having a trough depth of about 0.090 inches, a groove width of about 0.078 inches, and a center spacing between adjacent grooves of about 0.10 inches.

Accordingly, a central conductor diameter, a, of about 0.030 inches, and a dielectric-covered central conductor diameter, b, of about 0.077 inches yields a characteristic impedance, Z₀, of about 50 Ω at the input and output of the microwave delay line 100. It is noted that a length, e.g., 210 inches, of the central conductor 105 helically wound a number of turns, e.g., 24, on the outer conductor 102 corresponds to a total delay of about 24.0 nsecs between the input and output of the microwave delay line 100.

By configuring the microwave TEM delay line 100 to include the solid outer conductor 102 having the guide 114 formed on the outer surface thereof into which the dielectric-covered central conductor 105 is disposed, the microwave delay line exhibits significantly less loss change and/or phase change when exposed to repeated thermal cycles. This is, at least in part, because the solid outer conductor 102 is configured as a single piece and therefore comprises no contact spots, as typically found in stranded or flexible-element outer conductors. Such contact spots can age with exposure to thermal cycling. It should be appreciated, however, that the solid outer conductor 102 of the microwave TEM delay line 100 is preferably made of a material having a coefficient of expansion that allows optimal phase/temperature performance within the range of operating frequencies. Moreover, the performance of the microwave TEM delay line 100 can vary on the order of about 1000 PPM depending on whether the microwave delay line is operated with or without the metal enclosure 108.

It will be further appreciated by those of ordinary skill in the art that modifications to and variations of the above-described microwave TEM delay line may be made without departing from the inventive concepts disclosed herein. Accordingly, the invention should not be viewed as limited except as by the scope and spirit of the appended claims.

What is claimed is:

1. A microwave delay line, comprising:
a central conductor having a length;
a dielectric material configured to cover the length of the central conductor; and
an outer conductor having a geometric cross-section and including at least one guide formed on a surface thereof, the dielectric-covered central conductor being disposed in the guide,
wherein the guide is configured to at least partially encompass the dielectric-covered central conductor disposed therein.

2. The microwave delay line of claim 1 further including a plurality of microwave connectors, the microwave connectors being mounted at respective ends of the outer conductor and operatively coupled to corresponding ends of the central and outer conductors.

3. The microwave delay line of claim 1 further including a cover configured to enclose the microwave delay line to prevent signal leakage and protect the microwave delay line from environmental damage.

4. The microwave delay line of claim 3 wherein the cover is made of a metallized plastic.

5. The microwave delay line of claim 1 wherein the guide formed on the surface of the outer conductor comprises a helical groove, the guide being further configured to allow the dielectric-covered central conductor disposed therein to wind a number of turns on the outer conductor.

6. The microwave delay line of claim 1 wherein the geometric cross-section of the outer conductor is substantially circular.

7. The microwave delay line of claim 1 wherein the geometric cross-section of the outer conductor is hollow.

8. The microwave delay line of claim 7 wherein the guide is formed on an inner surface of the hollow outer conductor.

9. The microwave delay line of claim 1 wherein the guide formed on the outer conductor surface is configured to have a rounded U-shaped cross-section.

10. The microwave delay line of claim 1 wherein the guide formed on the outer conductor surface is configured to have a flattened U-shaped cross-section.

11. The microwave delay line of claim 1 wherein the dielectric material is polytetrafluoroethylene.

12. The microwave delay line of claim 1 wherein the microwave delay line is configured to operate in a transverse electromagnetic field configuration.

13. The microwave delay line of claim 1 wherein the outer conductor is substantially planar.

14. The microwave delay line of claim 13 wherein the guide is formed in a serpentine configuration on the outer conductor surface.

15. The microwave delay line of claim 13 wherein the guide is formed in a spiral configuration on the outer conductor surface.

16. The microwave delay line of claim 1 further including at least one conductive, elongated, flexible or semi-rigid link extending from a respective end of the outer conductor and configured to at least partially encompass a portion of the dielectric-covered central conductor, the conductive link being electrically connected to the outer conductor.

17. A method of operating the microwave delay line of claim 1, comprising the steps of:
injecting a microwave signal into the microwave delay line at a first end of the dielectric-covered central conductor; and
receiving the microwave signal from the microwave delay line at a second end of the dielectric-covered central conductor.

18. The method of claim 17 further comprising the step of providing respective microwave connectors at the first and second ends of the dielectric-covered central conductor.

19. The method of claim 17 further comprising the step of providing a metal cover to enclose the microwave delay line, thereby preventing leakage of the microwave signal injected into the microwave delay line and preventing environmental damage to the microwave delay line.

20. A method of manufacturing a microwave delay line, comprising the steps of:
providing a central conductor having a length;
covering the length of the central conductor with a dielectric material;
providing an outer conductor having a geometric cross-section; and
forming at least one guide on a surface of the outer conductor and disposing the dielectric-covered central conductor in the guide,
wherein the guide is formed on the outer conductor surface to at least partially encompass the dielectric-covered central conductor disposed therein.

21. The method of claim 20 further including the step of providing a plurality of microwave connectors and operatively coupling the microwave connectors to corresponding ends of the central and outer conductors.

22. The method of claim 20 further including the step of providing a metal cover and enclosing the microwave delay line with the metal cover to prevent signal leakage and protect the microwave delay line from environmental damage.

23. The method of claim 20 wherein the forming step includes forming the guide as a helical groove on the outer conductor surface.

24. The method of claim 20 wherein the second providing step includes providing an outer conductor having a geometric cross-section that is substantially circular.
